(19) United States
(12) Patent Application Publication
(10) Pub. No.: US 2009/0103179 A1
(43) Pub. Date: Apr. 23, 2009

(54) PROJECTION DEVICE WITH POLARIZATION CONVERTER

(75) Inventor: PI-TSUNG HSU, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/141,087

(22) Filed: Jun. 18, 2008

(30) Foreign Application Priority Data
Oct. 23, 2007 (CN) 200710202221.7

(51) Int. Cl. G02B 5/30; F21V 9/14

(52) U.S. Cl. 359/485; 362/19; 359/483

(57) ABSTRACT

A projector (100) includes a light source (10) for generating non-polarized light beams, and a polarization converter (40) for converting the non-polarized light beams into linearly polarized light beams. The polarization converter includes a first glass substrate (42) forming a plurality of parallel first polarization splitting films (42a), and a second glass substrate (44) forming a plurality of parallel second polarization splitting films (44a). The first and second polarization splitting films are aslant. A connecting surface (424) is formed on the first glass substrate, and the second glass substrate is assembled to the connecting surface of the first glass substrate. A positioning surface is configured for satisfactorily aligning the non-polarized light beams with the first and second polarization splitting films. The positioning surface and the connecting surface are coplanar.

### BACKGROUND

1. Technical Field

The present invention relates to polarization conversion systems, and particularly, to a polarization converter and a projector employing the converter.

2. Description of the Related Art

Polarization conversion systems are utilized in projectors requiring polarized light for operation. The polarization conversion device (PCD) is positioned in the optical path of the light source of the projector and converts the light beam emitted from the light source of two orthogonal polarization states to a single-polarized light beam.

Generally, when aligning incident light with a typical PCD, hazed surfaces of the PCD are used for positioning. However, alignment of the incident light with a typical PCD is not always satisfactory because the hazed surfaces of the PCD are formed by a polishing process.

What is needed, therefore, is to provide a polarization converter having a more accurate alignment with the incident light.

### SUMMARY

In accordance with an embodiment, a projector includes a light source for generating non-polarized light beams, and a polarization converter for converting the non-polarized light beams into linearly polarized light beams. The polarization converter includes a first glass substrate forming a plurality of parallel first polarization splitting films, and a second glass substrate forming a plurality of parallel second polarization splitting films. The first and second polarization splitting films are aslant. A connecting surface is formed on the first glass substrate, and the second glass substrate is assembled to the connecting surface of the first glass substrate. A positioning surface is configured for satisfactorily aligning the non-polarized light beams with the first and second polarization splitting films. The positioning surface and the connecting surface are coplanar.

Other advantages and novel features of the present invention will be drawn from the following detailed description of exemplary embodiments of the present invention with attached drawings.

### BRIEF DESCRIPTION OF THE DRAWINGS

FIG. 1 is a schematic view of a polarization converter in accordance with an exemplary embodiment of the present invention;

FIG. 2 is a front view of the polarization converter of FIG. 1;

FIG. 3 shows another exemplary embodiment of the polarization converter; and

FIG. 4 is a schematic view of a projector using the polarization converter of FIG. 1.

### DETAILED DESCRIPTION OF THE EMBODIMENTS

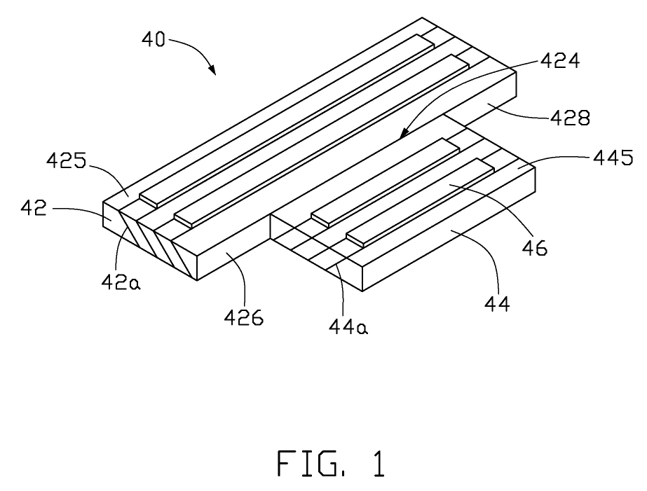

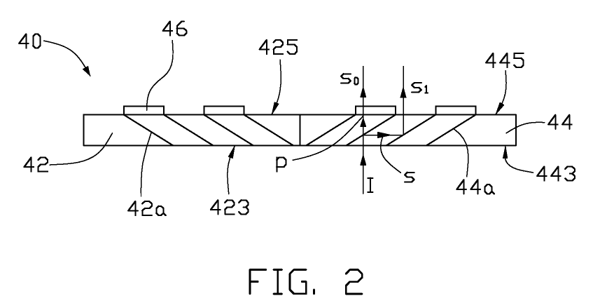

The detailed explanation of a polarization converter 40 according to an exemplary embodiment will now be made with reference to the drawings attached hereto. Referring to FIGS. 1 and 2, the polarization converter 40 includes a first glass substrate 42 and a second glass substrate 44.

The first glass substrate 42 has a bottom incident surface 423 for incidence of light beams and a top emitting surface 425 for emitting light beams. The second glass substrate 44 has a bottom incident surface 443 for incidence of light beams and a top emitting surface 445 for emitting light beams. Each of the glass substrates 42 and 44 forms a plurality of elongate polarization splitting films 42a and 44a therein. The first polarization splitting films 42a are aslant and parallel to each other, so are the second polarization splitting films 44a. In this embodiment, the first glass substrate 42 forms four first polarization splitting films 42a, and the second glass substrate 44 forms four second polarization splitting films 44a. The first polarization splitting films 42a and the second polarization splitting films 44a are in axial symmetry. Preferably, an inclination of the first polarization splitting films 42a to the emitting surface 425 of the first glass substrate 42 is 45 degree, and an inclination of the second polarization splitting films 44a to the emitting surface 445 of the second glass substrate 44 is also 45 degrees. Thus, the first polarization splitting films 42a are perpendicular to the second polarization splitting films 44a.

The first glass substrate 42 forms a connecting surface 424 on a side surface thereof perpendicular to both surfaces 423 and 425. A positioning surface (not labeled) is formed on the same side surface of the first glass substrate 42. The positioning surface and the connecting surface 424 are coplanar. The positioning surface has a first portion 426 and a second portion 428, located at two opposite ends of the connecting surface 424. The first portion 426 and the second portion 428 are substantially identical to each other. The two portions 426 and 428 of the positioning surface are symmetric to the connecting surface 424. The second glass substrate 44 has a size smaller than that of the first glass substrate 42. A side surface of the second glass substrate 44 has a size and shape approximately the same as the size and shape of the connecting surface 424 of the first glass substrate 42. In this embodiment, the second glass substrate 44 is glued, via the side surface thereof, to the connecting surface 424 of the first glass substrate 42. The first and second glass substrates 42, 44 are symmetrical to a central axis of the connecting surface 424.

A plurality of half-wave plates 46 are arranged on the emitting surfaces 425 and 445 of the glass substrates 42 and 44. In this embodiment, each of glass substrates 42 and 44 has two half-wave plates 46 formed thereon. The half-wave plates 46 are spaced from each other. Each half-wave plate 46 is located between every other two neighboring polarization splitting films 42a or 44a of each of the glass substrates 42 and 44. As the second glass substrate 44 is connected to first glass substrate 42 via the connecting surface 424, the two portions 426 and 428 of the positioning surface of the first glass substrate 42 are exposed to two opposite sides of the second glass substrate 44. The positioning of the second glass substrate 44 and the first glass substrate 42 is precise. After the first glass substrate 42 and the second glass substrate 44 being connected together, the central axis of the second glass substrate 44 is parallel with that of the first glass substrate 42.

Referring to FIG. 2, when aligning the polarization converter 40 with incident light beams indicated as I in FIG. 2, the first portion 426 and the second portion 428 of the positioning surface are used for positioning the first glass substrate 42 and the second glass substrate 44 of the polarization converter 40. Since the central axes of the first glass substrate 42 and the second glass substrate 44 are parallel, the incident light beams I can be satisfactorily aligned with the first polarization splitting film 42a, the second polarization splitting film 44a and the first and second half-wave plates 46. The non-polarized incident light beams I are incident on the incident surfaces 423 and 443 and travel upwardly. The light beams I then are incident on the polarization splitting films 42a and 44a with P-polarized light beams indicated as P penetrating through and S-polarized beams indicated as S being reflected. The P-polarized light beams P travel through the emitting surfaces 425 and 445 and finally are converted by the half-wave plates 46 as light beams S₀ of single S-polarization state. The S-polarized light beams S are further reflected by a neighboring polarization splitting film 42a and 44a and then travel through the emitting surfaces 425 and 445 between the half-wave plates 46 as light beams S₁ of single S-polarization state. Thus the non-polarized light beams I are converted in the polarization converter 40 and emitted from the polarization converter 40 as single S-polarized state light beams.

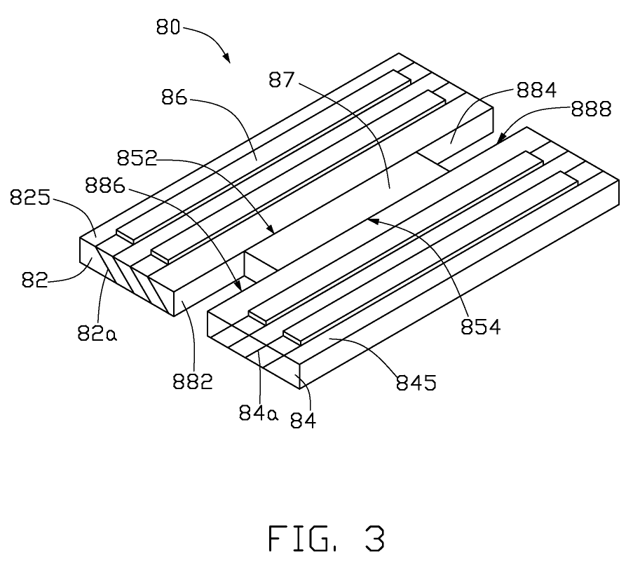

FIG. 3 shows an alternative embodiment of the present polarization converter 80. The polarization converter 80 includes a first glass substrate 82 forming a plurality of aslant first polarization splitting films 82a, a second glass substrate 84 forming a plurality of aslant second polarization splitting films 84a, a plurality of half-wave plates 86 arranged on the emitting surfaces 825 and 845 of the first glass substrate 82 and the second glass substrate 84, and a prism 87. The prism 87 can be a triangular prism or a rectangular prism. In this embodiment, the prism 87 is a tetragonal prism. A height of the prism 87 is the same as that of the glass substrates 82 and 84. Alternatively, the height of the prism 87 can be higher or less than that of the glass substrates 82 and 84. The first glass substrate 82 of this embodiment is substantially the same as that of the first embodiment. A first connecting surface 852 and a first positioning surface having first portion 882 and second portion 884 are formed on a side of the first glass substrate 82 facing the second glass substrate 84. The second glass substrate 84 has a shape and size substantially the same as that of the first glass substrate 82. A second connecting surface 854 is formed on a side surface of the second glass substrate 84 facing the first connecting surface 852. A second positioning surface (not labeled) is formed on the same side surface of the second glass substrate 852. The second positioning surface and the second connecting surface 854 are coplanar. The second positioning surface includes a first portion 886 and a second portion 888, located at two opposite ends of the first connecting surface 852. The first connecting surfaces 852 of the first glass substrates 82 and the second connecting surfaces 854 of the second glass substrates 84 are approximately the same in size.

When assembled, two opposite sides of the prism 87 can be glued to the connecting surfaces 852 and 854 of the glass substrates 82 and 84 respectively. The connecting surfaces 852 and 854 are thus arranged symmetric to a central axis of the prism 87. The positioning surfaces are located around the prism 87, and are also symmetric to the central axis of the prism 87. The first polarization splitting films 82a and the second polarization splitting films 84a are also symmetric about the central axis of the prism 87. The precise disposition of the second glass substrate 84 relative to the first glass substrate 82 is achieved. The incident light beams can be satisfactorily aligned with the first polarization splitting film 82a, the second polarization splitting film 84a and the half-wave plates 86. Thus the non-polarized light beams can be converted in the polarization converter 80 and emit from the polarization converter 80 as single S-polarized state light beams.

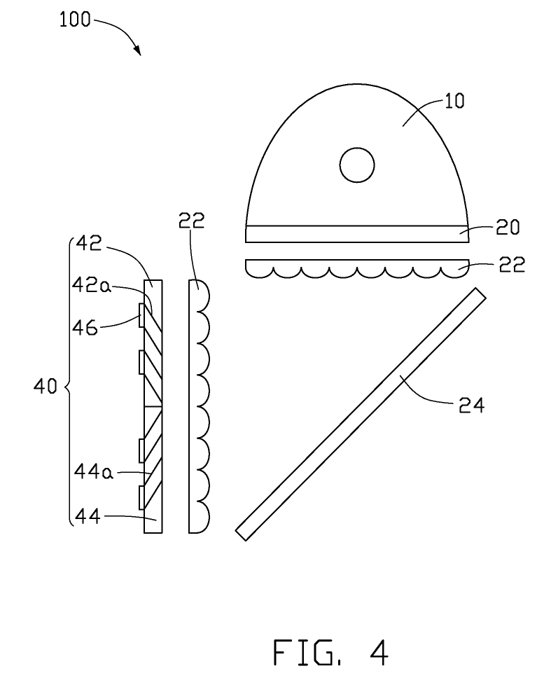

FIG. 4 shows a projector 100 using the polarization converter 40 of the first embodiment. The projector 100 includes a light source 10, an ultraviolet-infrared (UV-IR) filter 20 and two micro mirror arrays 22, a reflector 24, and the polarization converter 40. The polarization converter 80 described in the second embodiment is also suitable for use in the projector 100. Light beams emitted from the light source 10 go though the UV-IR filter 20, the micro mirror array 22, and then are reflected by the reflector 24 towards the other micro mirror array 22, and finally are incident on the polarization converter 40. The polarization converter 40 converts the light beams of the light source 10 into single S-polarized light beams for the projector 100. Since the polarization converter 40 is used in the projector 100, an incident light of the light source 10 can be satisfactorily aligned with the polarization splitting films 42a and 44a.

It is understood that the invention may be embodied in other forms without departing from the spirit thereof. Thus, the present exemplary embodiments are to be considered in all respects as illustrative and not restrictive, and the invention is not to be limited to the details given herein.

What is claimed is:

1. A polarization converter for converting non-polarized light beams into linearly polarized light beams, comprising:
a first glass substrate forming a plurality of first polarization splitting films therein, the first polarization splitting films being aslant and parallel to each other;
a second glass substrate forming a plurality of second polarization splitting films therein, the second polarization splitting films being aslant and parallel to each other;
a connecting surface formed on one of the first and second glass substrates, and the other one of the first and second glass substrates being assembled to the connecting surface of the one of the first and second glass substrates; and
a positioning surface being configured for satisfactorily aligning the non-polarized light beams with the first and second polarization splitting films, the positioning surface and the connecting surface being coplanar.

2. The polarization converter of claim 1, wherein the first and second polarization splitting films are axial symmetry.

3. The polarization converter of claim 1, wherein the positioning surface comprises a first portion and a second portion, the first and second portion being symmetrically arranged at two opposite ends of the connecting surface.

4. The polarization converter of claim 3, wherein the other of the first and second glass substrates has a width being substantially the same as that of the connecting surface.

5. The polarization converter of claim 1, wherein the other one of the first and second glass substrates contacts the connecting surface of the one of the first and second glass substrates directly.

6. The polarization converter of claim 1, wherein each of the first and second glass substrates forms one connecting surface, a prism being arranged between and interconnecting the connecting surfaces of the first and second glass substrates, the first and second polarization splitting films being arranged symmetric about a central axis of the prism.

7. The polarization converter of claim 6, wherein each of the first and second glass substrates forms one positioning surface, each positioning surface comprising two portions identical to each other, the two portions of each positioning surface being arranged at two opposite ends of a corresponding connecting surface symmetrically.

8. The polarization converter of claim 1, wherein a plurality of half-wave plates are arranged on an emitting surface of each glass substrates, the half-wave plates being spaced from each other, each half-wave plate being located between every other two neighboring polarization splitting films.

9. A projector comprising:
a light source for generating non-polarized light beams;
a polarization converter converting the non-polarized light beams into linearly polarized light beams, comprising:
a first glass substrate forming a plurality of first polarization splitting films therein, the first polarization splitting films being aslant and parallel to each other;
a second glass substrate forming a plurality of second polarization splitting films therein, the second polarization splitting films being aslant and parallel to each other;
a connecting surface formed on one of the first and second glass substrates, and the other one of the first and second glass substrates being assembled to the connecting surface of the one of the first and second glass substrates;
a positioning surface being configured for satisfactorily aligning the non-polarized light beams with the first and second polarization splitting films, the positioning surface and the connecting surface being coplanar.

10. The projector of claim 9, wherein the first and second polarization splitting films are axial symmetry.

11. The projector of claim 9, wherein the positioning surface comprises a first portion and a second portion, the first and second portion being symmetrically arranged at two opposite ends of the connecting surface.

12. The projector of claim 11, wherein the other of the first and second glass substrates has a width being substantially the same as that of the connecting surface.

13. The projector of claim 9, wherein each of the first and second glass substrates forms one connecting surface, a prism being arranged between and interconnecting the connecting surfaces of the first and second glass substrates, the first and second polarization splitting films being arranged symmetric about a central axis of the prism.

14. The projector of claim 13, wherein each of the first and second glass substrates forms one positioning surface, each positioning surface comprising two portions identical to each other, the two portions of each positioning surface being arranged at two opposite ends of a corresponding connecting surface symmetrically.

15. The projector of claim 9, wherein the other one of the first and second glass substrates contacts the connecting surface of the one of the first and second glass substrates directly.

16. The projector of claim 9, wherein a plurality of half-wave plates are arranged on an emitting surface of each glass substrates, the half-wave plates being spaced from each other, each half-wave plate being located between every other two neighboring polarization splitting films.
